(19) United States
(12) Patent Application Publication
(10) Pub. No.: US 2025/0215222 A1
(43) Pub. Date: Jul. 3, 2025

(54) ANTI-YELLOWING AND HIGHLY WEATHER-RESISTANT THERMOPLASTIC POLYURETHANE CURED PRODUCT AND METHOD FOR MANUFACTURING THE SAME

(71) Applicant: NAN YA PLASTICS CORPORATION, TAIPEI (TW)

(72) Inventors: TE-CHAO LIAO, TAIPEI (TW); CHING-YAO YUAN, TAIPEI (TW); CHEN-WEI CHANG, TAIPEI (TW); HAO-SHENG CHEN, TAIPEI (TW); SHANG-YOU SUN, TAIPEI (TW)

(21) Appl. No.: 18/599,131

(22) Filed: Mar. 7, 2024

(30) Foreign Application Priority Data
Dec. 27, 2023 (TW) 112150904

(51) Int. Cl. C08L 75/04; C08G 18/24; C08K 5/00; C08K 5/053; C08K 5/07; C08K 5/3435; C08K 5/3475; C08K 5/3492; C08K 5/521; C08K 5/524

(52) U.S. Cl. CPC C08L 75/04; C08G 18/244; C08K 5/005; C08K 5/053; C08K 5/07; C08K 5/3435; C08K 5/3475; C08K 5/34926; C08K 5/521; C08K 5/524; C08L 2666/82

(57) ABSTRACT

An anti-yellowing and highly weather-resistant thermoplastic polyurethane cured product and a method for manufacturing the same are provided. The thermoplastic polyurethane cured product includes a thermoplastic polyurethane, a UV absorber, and a light stabilizer combination. The thermoplastic polyurethane is formed from a reaction composition. The reaction composition includes an isocyanate component, a polyol component, and a glycol chain extender component. The polyol component is selected from the group consisting of polyether polyols, polyester polyols, and polycaprolactone polyols. The light stabilizer combination is a combination of a phosphorus light stabilizer, a hindered amine light stabilizer, and a hindered phenol light stabilizer.

### CROSS-REFERENCE TO RELATED PATENT APPLICATION

This application claims the benefit of priority to Taiwan Patent Application No. 112150904, filed on Dec. 27, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a thermoplastic polyurethane cured product, and more particularly to an anti-yellowing and highly weather-resistant thermoplastic polyurethane cured product, such as a cured particle product capable of being processed into a film.

### BACKGROUND OF THE DISCLOSURE

Thermoplastic polyurethane (TPU) is an environmentally friendly polymer whose products cover a range of industrial applications and civilian necessities. In addition, TPU materials have excellent physical and mechanical properties and can be compounded with other materials such as fibers and polyester to create new multifunctional products.

TPU materials that are commonly used have poor anti-yellowing properties. As the use time increases, products made of the TPU materials will begin to yellow under the influence of ultraviolet light. For example, a TPU transparent shell can change from being colorless to having an orange or yellow color. In addition, during the manufacturing of the TPU materials, certain small infusible crystals are inevitably present, which can cause the processed film to easily have defects in appearance such as crystal points and flow marks that affect the visual aspect of the product.

In addition, because the existing TPU materials have a wide molecular weight distribution and a large change in melt viscosity, the existing TPU materials are not suitable for being processed into films by hot-melting, and a laminating finished product is prone to having crystal points and can easily have a decreased physical property.

### SUMMARY OF THE DISCLOSURE

In response to the above-referenced technical inadequacies, the present disclosure provides an anti-yellowing and highly weather-resistant thermoplastic polyurethane cured product that is suitable for a laminating process, and a coating produced from the laminating process has good appearance and quality. The present disclosure further provides a method for manufacturing the anti-yellowing and highly weather-resistant thermoplastic polyurethane cured product.

In order to solve the aforementioned problems, one of the technical aspects adopted by the present disclosure is to provide an anti-yellowing and highly weather-resistant thermoplastic polyurethane cured product. The anti-yellowing and highly weather-resistant thermoplastic polyurethane cured product includes a thermoplastic polyurethane, a UV absorber, and a light stabilizer combination. Based on a total weight of the anti-yellowing and highly weather-resistant thermoplastic polyurethane cured product, a content of the thermoplastic polyurethane is from 97% by weight to 99% by weight, a content of the UV absorber is from 0.1% by weight to 0.5% by weight, and a content of the light stabilizer combination is from 0.3% by weight to 1% by weight. The thermoplastic polyurethane is formed from a reaction composition, the reaction composition includes an isocyanate component, a polyol component, and a glycol chain extender component, and the polyol component is selected from the group consisting of polyether polyols, polyester polyols, and polycaprolactone polyols. The light stabilizer combination is a combination of a phosphorus light stabilizer, a hindered amine light stabilizer, and a hindered phenol light stabilizer.

In order to solve the aforementioned problems, another one of the technical aspects adopted by the present disclosure is to provide a method for manufacturing an anti-yellowing and highly weather-resistant thermoplastic polyurethane cured product. The method includes processes as follows: carrying out a polymerization reaction by adding a reaction composition, a UV absorber, and a light stabilizer combination into an extruder; a ratio of NCO to OH being from 0.98 to 1.02 to form a thermoplastic polyurethane composition; and extruding and pelletizing the thermoplastic polyurethane composition to obtain a plurality of the anti-yellowing and highly weather-resistant thermoplastic polyurethane cured products; based on a total weight of the anti-yellowing and highly weather-resistant thermoplastic polyurethane cured product, a content of the thermoplastic polyurethane being from 97% by weight to 99% by weight, a content of the UV absorber being from 0.1% by weight to 0.5% by weight, and a content of the light stabilizer combination being from 0.3% by weight to 1% by weight; the light stabilizer combination being a combination of a phosphorus light stabilizer, a hindered amine light stabilizer, and a hindered phenol light stabilizer.

In one of the possible or preferred embodiments, a weight ratio of the phosphorus light stabilizer, the hindered amine light stabilizer, and the hindered phenol light stabilizer is 1:1.5:3.

In one of the possible or preferred embodiments, in the reaction composition, based on an amount of the polyol component being 100 parts by weight, an amount of the isocyanate component is from 62 parts by weight to 66 parts by weight, and an amount of the glycol chain extender component is from 13 parts by weight to 15 parts by weight.

In one of the possible or preferred embodiments, the isocyanate component is methylene diphenyl diisocyanate.

In one of the possible or preferred embodiments, the glycol chain extender component is at least one of a linear glycol and a branched glycol having a number average molecular weight of less than 500 g/mol.

In one of the possible or preferred embodiments, the glycol chain extender is 1,4-butanediol.

In one of the possible or preferred embodiments, the reaction composition contains stannous octoate as a catalyst, and based on a weight of the polyol component being 100 parts by weight, the amount of catalyst is from 0.04 parts by weight to 0.06 parts by weight.

In one of the possible or preferred embodiments, the UV absorber is at least one of 2-hydroxy-4-methoxybenzophenone and 2-(2-hydroxy-5-methylphenyl)-2H-benzotriazole.

In one of the possible or preferred embodiments, the phosphorus light stabilizer is at least one of tris(2,4-di-tert-butylphenyl)phosphate ester and tris(2,4-di-tert-butylphenyl)phosphite ester, the hindered amine light stabilizer is at least one of 2,4-bis [N-butyl-N-(1-cyclohexyloxy-2,2,6,6-tetramethylpiperidin-4-yl)amino]-6-(2-hydroxyethylamine)-1,3,5-triazine) and polysuccinic acid (4-hydroxy-2,2,6,6-tetramethyl-1-piperidine ethanol) ester, and the hindered phenol light stabilizer is 2,2′-methylenebis(6-tert-butyl-4-methylphenol).

In one of the possible or preferred embodiments, the polyester polyol is selected from the group consisting of poly(adipic acid)-1,4-butanediol ester diol, poly(adipic acid)-ethylene glycol-1,4-butanediol ester glycol, and poly(adipic acid)-butanedioic acid-hexanediol ester diol, and the polyether polyol is selected from the group consisting of polyoxyethylene glycol, polyoxypropylene glycol, and polyoxytetramethylene glycol.

Therefore, in the anti-yellowing and highly weather-resistant thermoplastic polyurethane cured product and the method for manufacturing the same provided by the present disclosure, by virtue of “based on a total weight of the anti-yellowing and highly weather-resistant thermoplastic polyurethane cured product, a content of the thermoplastic polyurethane being from 97% by weight to 99% by weight, a content of the UV absorber being from 0.1% by weight to 0.5% by weight, and a content of the light stabilizer combination being from 0.3% by weight to 1% by weight,” “the polyol component being selected from the group consisting of polyether polyols, polyester polyols, and polycaprolactone polyols,” and “the light stabilizer combination being a combination of a phosphorus light stabilizer, a hindered amine light stabilizer, and a hindered phenol light stabilizer,” the appearance of a thermoplastic polyurethane film can be improved, and anti-yellowing and weather-resistant characteristics of the thermoplastic polyurethane film can be ensured.

Furthermore, a film that is produced by a laminating process using the anti-yellowing and highly weather-resistant thermoplastic polyurethane cured product provided in the present disclosure does not have crystal points in appearance and has good transparency, and further has excellent anti-yellowing and highly weather-resistant performances, such that the film has a wide range of applications in the field of film products.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a manufacturing method of a highly weather-resistant and anti-yellowing thermoplastic polyurethane cured product according to the present disclosure; and

FIG. 2 is a schematic view of a process of laminating the highly weather-resistant and anti-yellowing thermoplastic polyurethane cured product according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

Unless otherwise defined, terms used herein have the same meanings as commonly understood by those skilled in the art. The materials involved in each embodiment are commercially available or prepared according to the existing technology unless otherwise specified. The operations or instruments involved in each embodiment are conventional operations or instruments in the art unless otherwise specified.

Products made from thermoplastic polyurethane (TPU) are easily affected by light (especially ultraviolet light), heat, oxygen, and moisture in various environments or production processes, resulting in deterioration of appearance and mechanical properties. In addition, because thermoplastic polyurethane has a wide molecular weight distribution and a large change in melt viscosity, the thermoplastic polyurethane is not suitable for being melt processed into films by hot-melting, and a laminating finished product is prone to have crystal points. Therefore, in the present disclosure, the reaction composition of thermoplastic polyurethane with selected UV absorbers and light stabilizers are mixed and pelletized to obtain an anti-yellowing and highly weather-resistant thermoplastic polyurethane cured product suitable for laminating processing, and the film produced has no crystalline appearance, good transparency, excellent yellowing resistance and weather resistance, such that the film has wide applications in the field of film products.

Specifically, embodiments of the present disclosure provide an anti-yellowing and highly weather-resistant thermoplastic polyurethane cured product. The anti-yellowing and highly weather-resistant thermoplastic polyurethane cured product includes a thermoplastic polyurethane, a UV absorber, and a light stabilizer combination. Based on a total weight of the thermoplastic polyurethane cured product, a content of the thermoplastic polyurethane is from 97% by weight to 99% by weight, a content of the UV absorber is from 0.1% by weight to 0.5% by weight, and a content of the light stabilizer combination is from 0.3% by weight to 1% by weight. The thermoplastic polyurethane, the UV absorber, and the light stabilizer combination are described in detail as follows.

### [Thermoplastic Polyurethane]

The thermoplastic polyurethane constituting the thermoplastic polyurethane cured product of the present disclosure is formed from a reaction composition, and the reaction composition includes an isocyanate component, a polyol component and a glycol chain extender component.

In the embodiments of the present disclosure, the isocyanate component may include polyisocyanate compounds, such as but not limited to compounds with two or more isocyanate groups. Specific examples of polyisocyanate compounds include: 2,4-toluene diisocyanate, 2,6-toluene diisocyanate, a mixture of 2,4-toluene diisocyanate and 2,6-toluene diisocyanate (TDI), 4,4′-diphenylmethane diisocyanate (MDI), 1,5-naphthalene diisocyanate (NDI), 3,3′-dimethyl-4,4′-diphenyl diisocyanate (TODI), xylylene diisocyanate (XDI), tetramethylxylylene diisocyanate (TMXDI), paraphenylene diisocyanate (PPDI), and other aromatic diisocyanates; alicyclic diisocyanates or aliphatic diisocyanates such as 4,4′-dicyclohexylmethane diisocyanate (H12MDI), hydrogenated xylylene diisocyanate (H6XDI), hexamethylene diisocyanate (HDI), isophorone diisocyanate (IPDI), norbornane diisocyanate (NBDI); and modifications or addition compounds of the aforementioned diisocyanates. The aforementioned polyisocyanate compounds may be used separately, or two or more types of the aforementioned polyisocyanate compounds may be used in conjunction.

Considering the comprehensive performance of thermoplastic polyurethane film, the isocyanate component contains more than 50% of MDI. Preferably, the isocyanate component contains more than 80% of MDI. More preferably, the isocyanate component is all MDI.

In the embodiments of the present disclosure, the polyol component may include high molecular weight polyols with a number average molecular weight of more than 500 g/mol, such as but not limited to polyether polyols, polyester polyols, polycaprolactone polyols, polycarbonate polyol, polyurethane polyol, and acrylic polyol.

Furthermore, the polyol component may be selected from the group consisting of polyether polyol, polyester polyol and polycaprolactone polyol. Specific examples of the polyester polyol include: poly(adipic acid)-1,4-butanediol ester diol, poly(adipic acid)-ethylene glycol-1,4-butanediol ester glycol, and poly(adipic acid)-butanedioic acid-hexanediol ester diol. Poly(adipic acid)-1,4-butanediol ester diol is formed by the polymerization reaction of adipic acid and 1,4-butanediol. Poly(adipic acid)-ethylene glycol-1,4-butanediol ester glycol is formed by the polymerization reaction of adipic acid, ethylene glycol, and 1,4-butanediol. Poly(adipic acid)-butanedioic acid-hexanediol ester diol is formed by the polymerization reaction of adipic acid, succinic acid, and hexylene glycol. Specific examples of the polyether polyol include polyoxyethylene glycol, polyoxypropylene glycol, and polyoxytetramethylene glycol. However, the present disclosure is not limited to the above examples.

In practical applications, the high molecular weight polyol (a first polyol) may have a number average molecular weight between 600 g/mol and 2,000 g/mol, such that a softening temperature of the thermoplastic polyurethane that is produced can be decreased. It is worth noting that, when the softening temperature of thermoplastic polyurethane decreases, most thermoplastic polyurethane can be fully melted or softened at the processing temperature of a laminating processing. Therefore, the issue that thermoplastic polyurethane is prone to have defects in appearance such as crystal points and flow marks during film processing can be improved.

In practical applications, the high molecular weight polyol (a second polyol) may have a number average molecular weight between 1,500 g/mol and 3,000 g/mol to ensure that the formed thermoplastic polyurethane has improved mechanical strength.

The aforementioned first polyol and the second polyol can be used together, and a weight ratio range of the first polyol to the second polyol is preferably from 1:0.23 to 1:0.25.

Furthermore, the first polyol may be selected from the group consisting of polyether polyol, polyester polyol, and polycaprolactone polyol. Similarly, the second polyol may be selected from the group consisting of polyether polyol, polyester polyol, and polycaprolactone polyol. Specific examples of the polyester polyol include: poly(adipic acid)-1,4-butanediol ester diol, poly(adipic acid)-ethylene glycol-1,4-butanediol ester glycol, and poly(adipic acid)-butanedioic acid-hexanediol ester diol. Poly(adipic acid)-1,4-butanediol ester diol is formed by the polymerization reaction of adipic acid and 1,4-butanediol. Poly(adipic acid)-ethylene glycol-1,4-butanediol ester glycol is formed by the polymerization reaction of adipic acid, ethylene glycol, and 1,4-butanediol. Poly(adipic acid)-butanedioic acid-hexanediol ester diol is formed by the polymerization reaction of adipic acid, succinic acid, and hexylene glycol. Specific examples of the polyether polyol include polyoxyethylene glycol, polyoxypropylene glycol, and polyoxytetramethylene glycol. However, the present disclosure is not limited to the above examples.

In certain embodiments, the first polyol and/or the second polyol can be modified through side chain grafting to reduce the crystallinity of the formed thermoplastic polyurethane, thereby improving the phenomenon of small infusible crystals being formed during the reaction of raw materials, such that a high-quality transparent film with no crystal points and no flow marks can be obtained. The graft modifier of the first polyol and/or the second polyol can be glycols with carbon chain lengths from C3 to C10, such as, but not limited to diethylene glycol (DEG), 1,3-butanediol, 2-methyl-1,3-propanediol, neopentyl glycol, 1,6-hexanediol, and 3-methyl-1,5-pentanediol.

In the embodiments of the present disclosure, the glycol chain extender component may be at least one of a linear glycol and a branched glycol. The carbon chain length of the linear glycol can be from C2 to C6, and the linear glycol can be, but not limited to 1,4-butanediol and ethylene glycol. The carbon chain length of the branched glycol can be C3 to C10, and the branched glycol can be, but not limited to 2-methyl-1,3-propanediol, neopentyl glycol, and 3-methyl-1,5-pentanediol. Preferably, the glycol chain extender is 1,4-butanediol.

The aforementioned linear glycol can improve mechanical strength of the formed thermoplastic polyurethane. In addition, the aforementioned branched glycol has side chains or ether groups that are capable of increasing the steric hindrance of the molecular chain of the formed thermoplastic polyurethane and reducing the crystallinity of the thermoplastic polyurethane. Therefore, the issue of small infusible crystals being formed during the manufacturing of thermoplastic polyurethane cured products can be improved, thereby completely eliminating crystal spots and flow marks on the film.

In practical applications, the aforementioned linear diol and branched diol can be used together, and a weight ratio of linear diol to branched diol is preferably in the range of from 10:1 to 15:1. It is worth noting that, adjusting the weight ratio of the linear glycol to the branched glycol within this range can enable the formed thermoplastic polyurethane to have the required crystallinity and ideal mechanical strength.

In the embodiments of the present disclosure, in the reaction composition, based on an amount of the polyol component being 100 parts by weight, an amount of the isocyanate component can be from 62 parts by weight to 66 parts by weight, and an amount of the glycol chain extender component can be from 13 parts by weight to 15 parts by weight. In addition, a ratio of NCO to OH of the reaction composition during the polymerization reaction (i.e., a molar ratio of the NCO group of the isocyanate component to the OH group of the polyol and chain extender components) should be controlled to be in the range of from 0.98 to 1.02, and preferably within a range of from 0.995 to 1.005, such that the formed thermoplastic polyurethane has characteristics such as stable molecular weight, narrow molecular weight distribution, and good processing fluidity. If the ratio of NCO to OH of the reaction composition during the polymerization reaction is not within the aforementioned range, the formed thermoplastic polyurethane may have problems of poor heat resistance and difficulty in processing, and the formed thermoplastic polyurethane is prone to have defects in appearance such as crystal points and flow marks.

In practical applications, the reaction composition may include a catalyst to accelerate the reaction between the NCO group of the isocyanate component and the OH group of the polyol and chain extender components. Suitable catalysts include, but are not limited to, stannous octoate, amine catalysts, bismuth catalysts, and antimony catalysts, and preferably stannous octoate. In the reaction composition, based on a weight of the polyol component being 100 parts by weight, the amount of catalyst is from 0.04 parts by weight to 0.06 parts by weight.

### [UV Absorber]

The UV absorber constituting the thermoplastic polyurethane cured product of the present disclosure is selected from benzotriazoles and benzophenones that can provide excellent ultraviolet resistance for the thermoplastic polyurethane. The benzotriazoles UV absorber is preferably 2-(2-hydroxy-5-methylphenyl)-2H-benzotriazole, and the benzophenone UV absorber is preferably 2-hydroxy-4-methoxybenzophenone.

In the embodiments of the present disclosure, the UV absorber can be at least one of 2-hydroxy-4-methoxybenzophenone and 2-(2-hydroxy-5-methylphenyl)-2H-benzotriazole. Therefore, the UV absorber can prevent or slow down the aging phenomenon of thermoplastic polyurethane cured products or processed products of the thermoplastic polyurethane cured products caused by ultraviolet light, thereby maintaining the hue stability and mechanical properties of processed products (such as transparent films) and increasing durability when the processed products are exposed to ultraviolet light.

### [Light Stabilizer Combination]

The light stabilizer combination that constitutes the thermoplastic polyurethane cured product of the present disclosure is a combination of a phosphorus light stabilizer, a hindered amine light stabilizer, and a hindered phenol light stabilizer. The light stabilizer combination can capture free radicals generated by ultraviolet light oxidation to prevent the thermoplastic polyurethane cured product or processed products of the thermoplastic polyurethane cured product from continuing to deteriorate. In other words, the light stabilizer combination can remediate the areas of photooxidation caused by ultraviolet rays to make up for the lack of UV absorbers. Therefore, when the aforementioned light stabilizer combination is used in conjunction with the UV absorber, a more complete protection can be provided for the thermoplastic polyurethane cured product or processed products of the thermoplastic polyurethane cured product.

In the embodiment of the present disclosure, the phosphorus light stabilizer is preferably at least one of tris(2,4-di-tert-butylphenyl)phosphate ester and tris(2,4-di-tert-butylphenyl)phosphite ester. The hindered amine light stabilizer is preferably at least one of 2,4-bis [N-butyl-N-(1-cyclohexyloxy-2,2,6,6-tetramethylpiperidin-4-yl)amino]-6-(2-hydroxyethylamine)-1,3,5-triazine) (TINUVIN B97) and polysuccinic acid (4-hydroxy-2,2,6,6-tetramethyl-1-piperidine ethanol) ester. The hindered phenol light stabilizer is preferably 2,2′-methylenebis(6-tert-butyl-4-methylphenol). It is worth noting that, the aforementioned phosphorus light stabilizer, the hindered amine light stabilizer, and the hindered phenol light stabilizer can synergistically produce excellent light stability and prevent problems such as yellowing and performance degradation caused by photoaging. Preferably, the weight ratio of the aforementioned phosphorus light stabilizer to the hindered amine light stabilizer and hindered phenol light stabilizer is 1:1.5:3.

### [Production Method of Thermoplastic Polyurethane Cured Product]

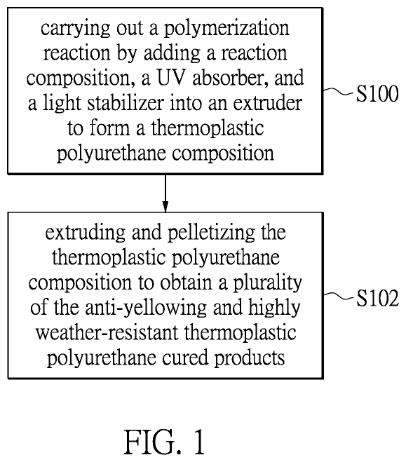

Referring to FIG. 1, FIG. 1 is a flowchart of a method for manufacturing the thermoplastic polyurethane cured product of the present disclosure. As shown in FIG. 1, the manufacturing method of the thermoplastic polyurethane cured product of the present disclosure is a continuous method, and the method includes processes as follows. Step S100 includes: carrying out a polymerization reaction by adding a reaction composition, a UV absorber, and a light stabilizer into an extruder; the ratio of NCO to OH being from 0.98 to 1.02 to form a thermoplastic polyurethane composition. Step S102 includes: extruding and pelletizing the thermoplastic polyurethane composition to obtain a plurality of the anti-yellowing and highly weather-resistant thermoplastic polyurethane cured products.

In step S100, the reaction composition, the UV absorber, the light stabilizer combination, and the selectively added catalyst and other additives are individually or jointly fed according to measurements described in the embodiment of the present disclosure to the extruder (such as a twin-screw reaction extruder) such that the reaction is carried out in the extruder. The specific types or substances of the reaction composition, the UV absorber, the light stabilizer combination, and the catalyst are as mentioned above and are not be reiterated herein. The temperature during the reaction extrusion process is controlled to be between 150° C. and 250° C. to facilitate the complete progression of the polymerization reaction.

In practical applications, a real-time viscosity of the melt can be monitored online and the feed amount of the isocyanate component, polyol component, or chain extender component can be accordingly adjusted, so as to control the ratio of NCO to OH in the polymerization reaction to be within the above range, or maintain a stable melt viscosity during reaction extrusion.

In step S102, after the thermoplastic polyurethane composition is extruded from the die, the thermoplastic polyurethane composition undergoes pelletizing in water to cut out the particle cured product, dehydrating, and sorting to obtain a particle product (i.e., the granular thermoplastic polyurethane cured product) that meets the standards.

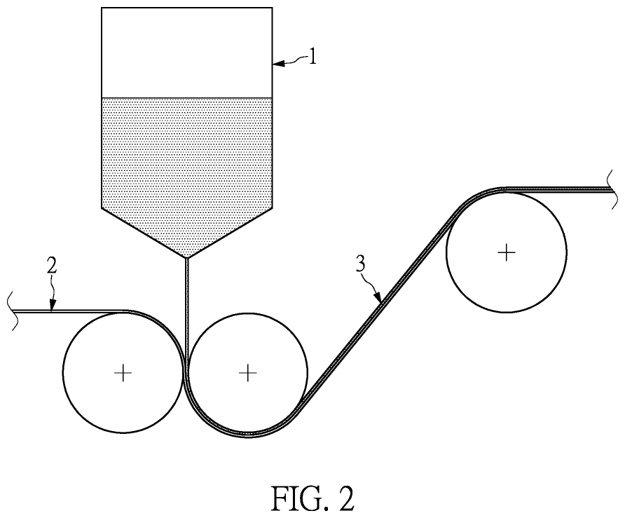

As shown in FIG. 2, the thermoplastic polyurethane cured product of the present disclosure can be used to manufacture films via laminating processing. Specifically, the thermoplastic polyurethane cured product is first heated and melted, and then a laminating head 1 pours the melt onto a carrier 2 such as a release paper or a polyester film that dynamically moves, so as to form a film layer 3. A thickness of the film layer 3 can be adjusted according to requirements.

Tests conducted according to ASTM G155 specifications are as follows.

In the present disclosure, “light stability” is evaluated by simulating a color change before and after sunlight exposure. Referring to Table 1 to Table 3 below, test pieces manufactured from the raw materials of Example 1 to Example 6 and Comparative Example 1 to Comparative Example 3 are placed into a xenon test chamber from Q-LAB for testing; the test piece is made by adding 30 grams of TPU glue. The pellets are placed into a mold having a size of approximately 7 cm×11 cm×2 mm (i.e., length×width×height), and are hot-pressed by a hot-pressing molding machine. The test light source is a xenon lamp; the irradiation intensity is 0.35 watts/square meter (W/m²); the irradiation temperature is from 28° C. to 50° C.; the irradiation durations are 100 hours, 200 hours, and 500 hours; and the irradiation direction is a direction toward the light incident surface of the test piece. Afterwards, a spectrophotometer is used according to JIS K8781-4:2013, and the color difference value ΔE is used as a basis for determining hue changes. The longer the irradiation time is, the greater energy the test pieces received is, and the easier yellowing occurs. The smaller the ΔE value shown in Table 1 to Table 3 is, the better the light resistance stability of the test pieces (the better the anti-yellowing effect) is.

In Table 1 to Table 3, the details of each additive are as follows: UV absorber: product model UV-5411;
Phosphorus light stabilizer: product model 6601;
Hindered amine light stabilizer: product model 6602; and
Hindered phenol light stabilizer: product model TINUVIN B97.

TABLE 1

| | | Comparative | Comparative | Comparative |
|---|---|---|---|---|
| Items | | example 1 | example 2 | example 3 |
| Raw | Polyether | 100 | 100 | 100 |
| material | polyol | | | |
| | Polyester | 0 | 0 | 0 |
| | polyol | | | |
| | MDI | 64 | 64 | 64 |
| | 1,4- | 15 | 15 | 15 |
| | butanediol | | | |
| Additive | UV absorber | 0.1 | 0.1 | 0.1 |
| | Phosphorus | 0.1 | 0 | 0 |
| | light | | | |
| | stabilizer | | | |
| | Hindered | 0 | 0.15 | 0 |
| | amine light | | | |
| | stabilizer | | | |
| | Hindered | 0 | 0 | 0.3 |
| | phenol light | | | |
| | stabilizer | | | |
| | Stannous | 0.08 | 0.08 | 0.08 |
| | octoate | | | |
| Test | ΔE (100 | 6 | 8 | 7.7 |
| results | hours) | | | |
| | ΔE (200 | 13.5 | 14 | 13 |
| | hours) | | | |
| | ΔE (500 | 22 | 21 | 19.5 |
| | hours) | | | |

TABLE 2

| Items | | Example 1 | Example 2 | Example 3 |
|---|---|---|---|---|
| Raw | Polyether polyol | 100 | 100 | 0 |
| material | Polyester polyol | 0 | 0 | 100 |
| | MDI | 64 | 66 | 51 |
| | 1,4-butanediol | 15 | 16 | 8.5 |
| Additive | UV absorber | 0.1 | 0.2 | 0.4 |
| | Phosphorus light | 0.1 | 0.2 | 0.1 |
| | stabilizer | | | |
| | Hindered amine | 0.15 | 0.3 | 0.15 |
| | light stabilizer | | | |
| | Hindered phenol | 0.3 | 0.5 | 0.3 |
| | light stabilizer | | | |
| | Stannous octoate | 0.08 | 0.07 | 0.12 |
| Test | ΔE (100 hours) | 1.4 | 1.35 | 1.5 |
| results | ΔE (200 hours) | 1.7 | 1.6 | 1.6 |
| | ΔE (500 hours) | 5 | 4.5 | 5.5 |

TABLE 3

| Items | | Example 4 | Example 5 | Example 6 |
|---|---|---|---|---|
| Raw | Polyether polyol | 0 | 100 | 100 |
| material | Polyester polyol | 100 | 0 | 0 |
| | MDI | 53 | 64 | 66 |
| | 1,4-butanediol | 7.5 | 15 | 16 |
| Additive | UV absorber | 0.6 | 0.1 | 0.2 |
| | Phosphorus light | 0.2 | 0.1 | 0.2 |
| | stabilizer | | | |
| | Hindered amine | 0.3 | 0.15 | 0.3 |
| | light stabilizer | | | |
| | Hindered phenol | 0.5 | 0.3 | 0.5 |
| | light stabilizer | | | |
| | Stannous octoate | 0.12 | 0.08 | 0.07 |
| Test | ΔE (100 hours) | 1.6 | 1.4 | 1.35 |
| results | ΔE (200 hours) | 1.7 | 1.7 | 1.6 |
| | ΔE (500 hours) | 5.9 | 5 | 4.5 |

It can be seen from Table 3 that after 100 hours and 200 hours of simulated sunlight exposure, the color difference value ΔE of the test pieces made of the raw materials of Example 5 and Examples 6 is below 2, indicating that the degree of hue change is very small and basically unperceivable by human eyes in terms of the color difference between the two test pieces (that is, the two test pieces are usually considered to be of the same color). After 500 hours of simulated sunlight exposure, the color difference value ΔE of the test pieces made of the raw materials of Example 5 and Examples 6 is not greater than 5, which is much smaller than the color difference value ΔE (19.5 to 22) of the test pieces made of the raw materials of Comparative Examples 1 to 3. Therefore, in the present disclosure, by using the phosphorus light stabilizer, the hindered amine light stabilizer, and the hindered phenol light stabilizer in combination, the anti-yellowing effect is significantly better than the effects of using one or two of the phosphorus light stabilizer, the hindered amine light stabilizer, and the hindered phenol light stabilizer.

### Beneficial Effects of the Embodiments

In conclusion, in the anti-yellowing and highly weather-resistant thermoplastic polyurethane cured product and the method for manufacturing the same provided by the present disclosure, by virtue of “based on a total weight of the anti-yellowing and highly weather-resistant thermoplastic polyurethane cured product, a content of the thermoplastic polyurethane being from 97% by weight to 99% by weight, a content of the UV absorber being from 0.1% by weight to 0.5% by weight, and a content of the light stabilizer combination being from 0.3% by weight to 1% by weight,” “the polyol component being selected from the group consisting of polyether polyols, polyester polyols, and polycaprolactone polyols,” and “the light stabilizer combination being a combination of a phosphorus light stabilizer, a hindered amine light stabilizer, and a hindered phenol light stabilizer,” the appearance of a thermoplastic polyurethane film can be improved, and anti-yellowing and weather-resistant characteristics of the thermoplastic polyurethane film can be ensured.

Furthermore, a film that is produced by a laminating process using the anti-yellowing and highly weather-resistant thermoplastic polyurethane cured product provided in the present disclosure does not have crystal points in appearance and has good transparency, and further has excellent anti-yellowing and highly weather-resistant performances, such that the film has a wide range of applications in the field of film products.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An anti-yellowing and highly weather-resistant thermoplastic polyurethane cured product, comprising: a thermoplastic polyurethane, a UV absorber, and a light stabilizer combination, wherein, based on a total weight of the anti-yellowing and highly weather-resistant thermoplastic polyurethane cured product, a content of the thermoplastic polyurethane is from 97% by weight to 99% by weight, a content of the UV absorber is from 0.1% by weight to 0.5% by weight, and a content of the light stabilizer combination is from 0.3% by weight to 1% by weight;
wherein the thermoplastic polyurethane is formed from a reaction composition, the reaction composition includes an isocyanate component, a polyol component, and a glycol chain extender component, and the polyol component is selected from the group consisting of polyether polyols, polyester polyols, and polycaprolactone polyols;
wherein the light stabilizer combination is a combination of a phosphorus light stabilizer, a hindered amine light stabilizer, and a hindered phenol light stabilizer.

2. The anti-yellowing and highly weather-resistant thermoplastic polyurethane cured product according to claim 1, wherein a weight ratio of the phosphorus light stabilizer, the hindered amine light stabilizer, and the hindered phenol light stabilizer is 1:1.5:3.

3. The anti-yellowing and highly weather-resistant thermoplastic polyurethane cured product according to claim 1, wherein, in the reaction composition, based on an amount of the polyol component being 100 parts by weight, an amount of the isocyanate component is from 62 parts by weight to 66 parts by weight, and an amount of the glycol chain extender component is from 13 parts by weight to 15 parts by weight.

4. The anti-yellowing and highly weather-resistant thermoplastic polyurethane cured product according to claim 3, wherein the isocyanate component is methylene diphenyl diisocyanate.

5. The anti-yellowing and highly weather-resistant thermoplastic polyurethane cured product according to claim 3, wherein the glycol chain extender component is at least one of a linear glycol and a branched glycol having a number average molecular weight of less than 500 g/mol.

6. The anti-yellowing and highly weather-resistant thermoplastic polyurethane cured product according to claim 5, wherein the glycol chain extender is 1,4-butanediol.

7. The anti-yellowing and highly weather-resistant thermoplastic polyurethane cured product according to claim 1, wherein the reaction composition contains stannous octoate as a catalyst, and based on a weight of the polyol component being 100 parts by weight, the amount of catalyst is from 0.04 parts by weight to 0.06 parts by weight.

8. The anti-yellowing and highly weather-resistant thermoplastic polyurethane cured product according to claim 1, wherein the UV absorber is at least one of 2-hydroxy-4-methoxybenzophenone and 2-(2-hydroxy-5-methylphenyl)-2H-benzotriazole.

9. The anti-yellowing and highly weather-resistant thermoplastic polyurethane cured product according to claim 1, wherein the phosphorus light stabilizer is at least one of tris(2,4-di-tert-butylphenyl)phosphate ester and tris(2,4-di-tert-butylphenyl)phosphite ester, the hindered amine light stabilizer is at least one of 2,4-bis [N-butyl-N-(1-cyclohexyloxy-2,2,6,6-tetramethylpiperidin-4-yl)amino]-6-(2-hydroxyethylamine)-1,3,5-triazine) and polysuccinic acid (4-hydroxy-2,2,6,6-tetramethyl-1-piperidine ethanol) ester, and the hindered phenol light stabilizer is 2,2′-methylenebis(6-tert-butyl-4-methylphenol).

10. The anti-yellowing and highly weather-resistant thermoplastic polyurethane cured product according to claim 1, wherein the polyester polyol is selected from the group consisting of poly(adipic acid)-1,4-butanediol ester diol, poly(adipic acid)-ethylene glycol-1,4-butanediol ester glycol, and poly(adipic acid)-butanedioic acid-hexanediol ester diol, and the polyether polyol is selected from the group consisting of polyoxyethylene glycol, polyoxypropylene glycol, and polyoxytetramethylene glycol.

11. A method for manufacturing an anti-yellowing and highly weather-resistant thermoplastic polyurethane cured product, comprising processes as follows:
carrying out a polymerization reaction by adding a reaction composition, a UV absorber, and a light stabilizer combination into an extruder, wherein a ratio of NCO to OH is from 0.98 to 1.02 to form a thermoplastic polyurethane composition; wherein the reaction composition includes an isocyanate component, a polyol component, and a glycol chain extender component, and the polyol component is selected from the group consisting of polyether polyols, polyester polyols and polycaprolactone polyols; wherein the light stabilizer combination is a combination of a phosphorus light stabilizer, a hindered amine light stabilizer, and a hindered phenol light stabilizer; and
extruding and pelletizing the thermoplastic polyurethane composition to obtain a plurality of the anti-yellowing and highly weather-resistant thermoplastic polyurethane cured products; wherein, based on a total weight of the anti-yellowing and highly weather-resistant thermoplastic polyurethane cured product, a content of the thermoplastic polyurethane is from 97% by weight to 99% by weight, a content of the UV absorber is from 0.1% by weight to 0.5% by weight, and a content of the light stabilizer combination is from 0.3% by weight to 1% by weight.
